(19) United States
(12) Patent Application Publication
(10) Pub. No.: US 2019/0072001 A1
(43) Pub. Date: Mar. 7, 2019

(54) TURBOCHARGER

(71) Applicant: MAN ENERGY SOLUTIONS SE, Augsburg (DE)

(72) Inventors: Tobias WEISBROD, Augsburg (DE); Björn HOßBACH, Diedorf (DE)

(73) Assignee: MAN ENERGY SOLUTIONS SE

(21) Appl. No.: 16/118,012

(22) Filed: Aug. 30, 2018

(30) Foreign Application Priority Data
Sep. 5, 2017 (DE) 102017215569.8

(51) Int. Cl. F01D 25/24

(52) U.S. Cl. CPC F01D 25/243; F05D 2220/40

(57) ABSTRACT

A turbocharger, with a turbine a compressor, and a turbine and a compressor housing connected with a bearing housing. An inflow housing of the turbine housing and the bearing housing are connected via a fastening device such that the fastening device is mounted to a flange of the inflow housing with a first section and a second section overlaps a flange of the bearing housing at least in sections. Between the first section of the fastening device and nuts of the fasteners, resiliently deformable elements are positioned, which provide a preloading force and compensate for preload losses.

### BACKGROUND OF THE INVENTION

### 1. Field of the Invention

The invention relates to a turbocharger.

### 2. Description of the Related Art

From DE 10 2013 002 605 A1 the fundamental construction of a turbocharger is known. A turbocharger comprises a turbine in which a first medium is expanded. A turbocharger, furthermore, comprises a compressor in which a second medium is compressed, utilising energy extracted in the turbine during the expansion of the first medium. The turbine of the turbocharger comprises a turbine housing and a turbine rotor. The compressor of the turbocharger comprises a compressor housing and a compressor rotor. Between the turbine housing of the turbine and the compressor housing of the compressor a bearing housing is positioned, wherein the bearing housing on the one hand is connected to the turbine housing and on the other hand to the compressor housing. In the bearing housing, a shaft is mounted via which the turbine rotor is coupled to the compressor rotor.

From practice it is known that the turbine housing of the turbine, namely a so-called inflow housing, as well as the bearing housing, are connected to one another via a fastening device that is preferentially designed as clamping claw. Such a fastening device, designed as clamping claw, is mounted with a first section of the same to a flange of the turbine housing via fastening means and overlaps with a second section a flange of the bearing housing at least in sections. By way of such a fastening device, the combination of bearing housing and turbine housing is clamped, namely clamping a sealing cover and nozzle ring between turbine housing and bearing housing.

The turbine housing is filled with the first medium to be expanded, in particular with exhaust gas to be expanded. The inflow housing of the turbine housing conducts the exhaust gas in the direction of the turbine rotor. In the inflow housing, there is an overpressure relative to the surroundings, which is removed in the turbine subject to extracting energy during the expansion of the first medium. In the region of the connection of turbine housing or inflow housing and bearing housing, a leakage can occur so that the first medium to be expanded in the turbine can enter the surroundings via the connecting region between turbine housing and bearing housing.

In order to counteract such a leakage of the first medium to be expanded in the turbine, the clamping between turbine housing or inflow housing and bearing housing is increased according to practice, in particular via higher tightening torques for the fastening means, via which the fastening device preferentially designed as clamping claw is mounted to the turbine housing. Despite increased tightening torques, leakage cannot be prevented under certain conditions.

### SUMMARY OF THE INVENTION

One aspect of the present invention is based on creating a new type of turbocharger with improved connection of inflow housing and bearing housing.

According to a further aspect of the invention resiliently deformable elements are positioned between the first section of the fastening device and nuts of the fastening means, which provide a preloading force.

According to one aspect of the invention the fastening device as such is resiliently deformable and provides a preloading force.

According to one aspect of the invention a resiliently deformable element is positioned between the second section of the fastening device and the flange of the bearing housing, which provides a preloading force.

With all three aspects of the invention present here according to the invention it is possible to improve the connection between inflow housing and bearing housing. The risk of an unintentional leakage into the surroundings of the first medium to be expanded can be minimised.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the invention are explained in more detail by way of the drawings without being restricted to this. There it shows:

FIG. 1 is a cross section through a turbocharger;

FIG. 2 is a cross section through a turbocharger in a region of an inflow housing and of a bearing housing of the turbocharger;

FIG. 3 is a detail of FIG. 2;

FIG. 4 a cross section through a turbocharger in a region of an inflow housing and of a bearing housing of the turbocharger;

FIG. 5 is a cross section through a further turbocharger in a region of an inflow housing and of a bearing housing of the turbocharger;

FIG. 6 is an alternative for FIGS. 4 and 5;

FIG. 7 is a cross section through a further turbocharger in a region of an inflow housing and of a bearing housing of the turbocharger,

FIG. 8 is a cross section through a turbocharger in a region of an inflow housing and of a bearing housing of the turbocharger; and

FIG. 9 is a detail of FIG. 8.

### DETAILED DESCRIPTION OF THE PRESENTLY PREFERRED EMBODIMENTS

The invention relates to a turbocharger.

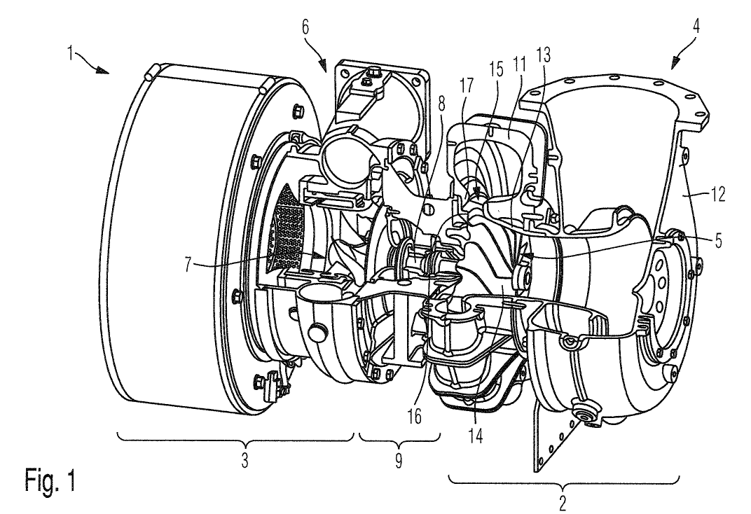

FIG. 1 shows the fundamental construction of a turbocharger 1. A turbocharger 1 comprises a turbine 2 for expanding a first medium, in particular for expanding exhaust gas of an internal combustion engine. Furthermore, the turbocharger 1 comprises a compressor 3 for compressing a second medium, in particular charge air, utilising energy extracted in the turbine 2 during the expansion of the first medium.

Here, the turbine 2 comprises a turbine housing 4 and a turbine rotor 5. The compressor 3 comprises a compressor housing 6 and a compressor rotor 7. The compressor rotor 7 is coupled to the turbine rotor 5 via a shaft 8, which is mounted in a bearing housing 9, wherein the bearing housing 9 is positioned between the turbine housing 4 and the compressor housing 5 and connected both to the turbine housing 4 and the compressor housing 5.

The turbine housing 4 of the turbine 2 comprises an inflow housing 11 and an outflow housing 12. By way of the inflow housing 11, the first medium to be expanded in the region of the turbine 2 can be fed to the turbine rotor 5. By way of the outflow housing 12, first medium expanded in the region of the turbine rotor 5 flows away from the turbine 2.

In addition to the inflow housing 11 and the outflow housing 12, the turbine housing 4 comprises an insert piece 13. The insert piece 13 runs in particular in the region of the inflow housing 11, and namely adjacently to the turbine rotor 5 radially outside adjoining moving blades 14 of the turbine rotor 5.

The turbine housing 4, furthermore, comprises a nozzle ring 15. The nozzle ring 15 is also referred to as turbine glide apparatus.

FIG. 1, furthermore, shows a sealing cover 16 in the connecting region of inflow housing 11 and bearing housing 9. The sealing cover 16 is also referred to as bearing housing cover or heat shield.

The inflow housing 11 of the turbine 2 is connected to the bearing housing 9 via a fastening device 17 such that the fastening device 17 is mounted to a flange 18 of the inflow housing 11 with a first section 19, namely via multiple fasteners 20, and that the fastening device 17 with a second section 21 overlaps a flange 26 of the bearing housing 9 at least in sections.

The fastening device 17 is also referred to as clamping claw. Seen in the circumferential direction, the fastening device 13 can be segmented.

Each fastener 20 comprises a threaded screw 22 screwed into the flange 18 of the inflow housing 11 and a nut 23 acting on the other end of the threaded screw 22, wherein by tightening the nuts 23 a defined preloading force can be exerted on the inflow housing 11 and on the bearing housing 9 via the fastening device 17. By way of this, corresponding flanges 24, 25 of nozzle ring 15 and sealing cover 16 are clamped between inflow housing 11 and bearing housing 9.

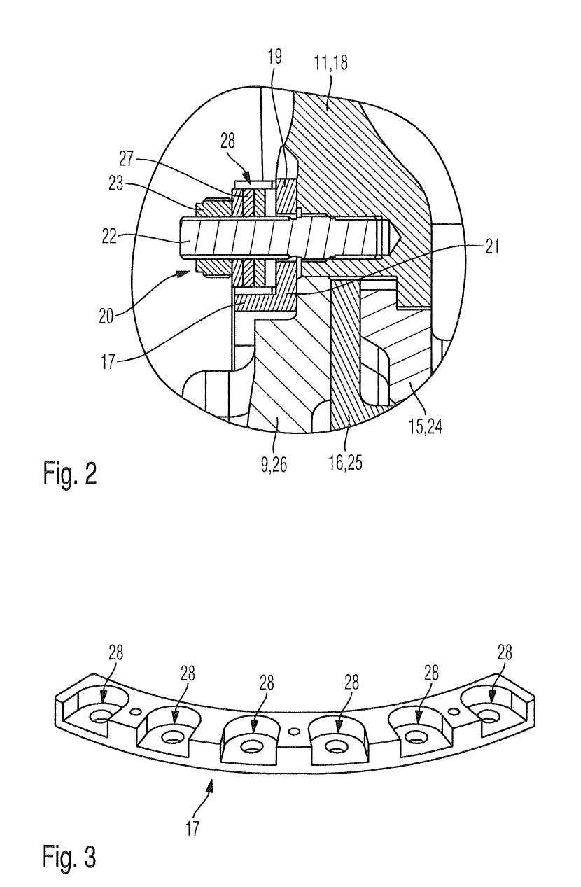

With the turbocharger of FIGS. 2 and 3 according to the first aspect of the invention, resiliently deformable elements 27 are positioned between the first section 19 of the fastening device 17 designed as clamping claw and the nuts 23 of the fastener 20, which are clamped by the tightening force of the nuts and provide a preloading force.

Here, with the turbocharger of FIGS. 2 and 3, multiple resiliently deformable elements 27 formed between the nut 23 of each fastener 20 and the first section 19 of the fastening device 17 are positioned in each case stack-like on top of one another or stack-like next to one another, wherein these disc springs 27 engage in pocket-like recesses 28 of the fastening device 17.

The number and orientation of the resiliently deformable elements 27, namely of the disc springs, combined stack-like determines on the one hand the preloading force and on the other hand a spring travel in the region of the connection of bearing housing 9 and inflow housing 11 of the turbine, wherein the disc springs can altogether be arranged in the same direction or partly in alternating direction. In particular when all disc springs are arranged in the same direction to form a corresponding stack, a high preloading force with small spring travel can be provided. By arranging the disc springs in alternating direction, a smaller preloading force with greater spring travel is provided.

Accordingly, in the exemplary embodiment of FIG. 2, 3, disc springs or resiliently deformable washers are positioned according to the first aspect of the invention between each nut 23 of each fastener 20 and the fastening device 17, which in the region of each nut 23 generate a preloading force namely in particular even when as a consequence of thermal cycles the assemblies to be connected to one another are subjected to a different expansion. As already explained, spring force and spring travel can be adjusted by way of the arrangement of the disc springs. Here, the disc springs can be arranged in alternating direction and in the same direction. By tightening the nuts 23, the disc spring assemblies are preloaded. Different thermal expansions of the assemblies connected to one another caused by thermal loads can be compensated for.

According to a second aspect of the invention, the fastening device 17, i.e. the clamping claw, as such is resiliently deformable and provides a corresponding preloading force with the help of which different thermal expansions of the assemblies connected to one another caused through thermal loads can be compensated for.

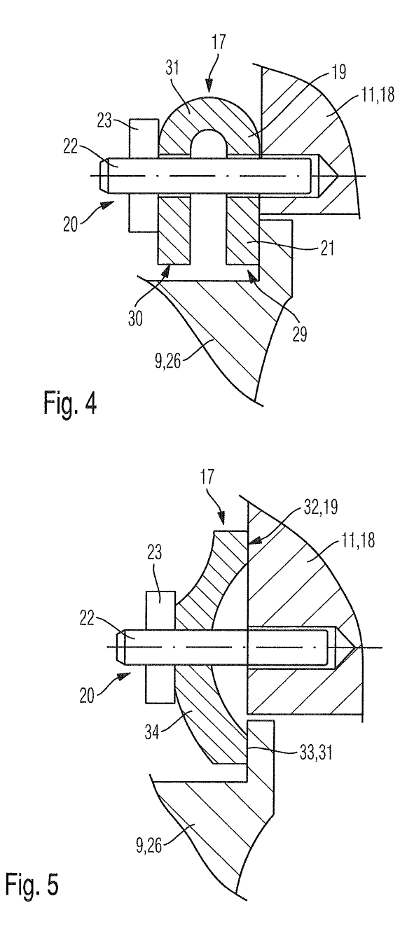

Here, FIG. 4 shows an embodiment of the turbocharger according to the second aspect of the invention, according to which the fastening device 17 is contoured U-like in cross section. A first leg 29 of the fastening device 17 contoured U-like in cross section provides the first section 19, with which the fastening device 17 lies against the flange 18 of the inflow housing 11, and provides the second section 21, with which the fastening device 17 overlaps the flange 26 of the bearing housing 9 in sections. A second leg 30 of the fastening device 17 contoured U-like in cross section extends parallel to this first leg 29 and is connected to this first leg 29 via a connecting section 31, wherein the nut 23 of the respective fastener 20 supports itself on the second leg 30.

By tightening the respective nut 23, the second leg 30 is resiliently deformed and deformed in the direction of the first leg 29. By way of this, a preloading force can be provided which can offset or compensate for thermally-induced deformations of the assemblies connected to one another.

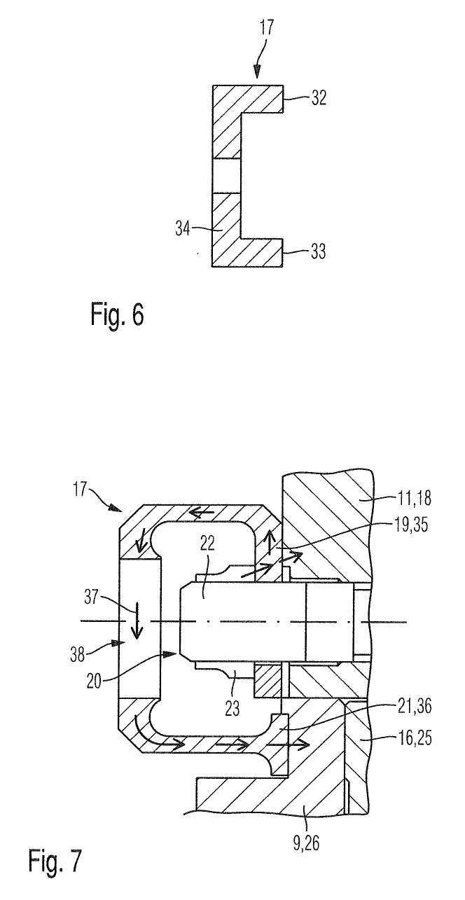

In the exemplary embodiment of FIG. 5 or FIG. 6, the fastening device 17 is contoured C-like or V-like. The fastening device 17 contoured C-like or V-like of the exemplary embodiment of FIG. 5 likewise comprises two legs which are connected to one another via a connecting section 34. A free end 32 of the first leg lies against the flange 18 of the inflow housing 11 and a free end of the second leg 33 lies against the flange 6 of the bearing housing 9. The nut 23 of the fastener 20 shown in FIG. 5 supports itself on the connecting section 34 of the fastening device 17 contoured C-like or V-like in cross section. In particular when the nut 23 is tightened, the connecting section 34 is elastically deformed and the entire fastening device 17 is pressed against the flanges 18, 26. By way of the resilient deformation of the fastening device 17, a preloading force for connecting bearing housing 9 and inflow housing 11 can be provided, which can compensate for different expansions, for example thermally-induced expansions, of these assemblies to be connected to one another and other preload losses in the connection.

FIG. 7 shows a further exemplary embodiment of a turbocharger according to the invention in accordance with the second aspect of the invention, according to which the fastening device 17, which as such is resiliently deformable, is helically contoured. Here, the helically contoured fastening device 17 comprises a first end 35 with which the fastening device 17 is mounted to the flange 18 of the inflow housing 11 via fastener 20. An end 36 of the fastening device 17 that is helically contoured in the cross section located opposite overlaps the flange 26 of the bearing housing 9 at least in sections and lies against the same.

The nut 23 of the fastener 20 supports itself on the first end 35 of the helically contoured fastening device 17. Arrows 37 visualise in FIG. 7 a force flow which, during the tightening of the nut 23, extends starting from the nut into the fastening device 17 and via the fastening device 17 into the flanges 18, 26 of inflow housing 11 and bearing housing 9. The nut 23 is accessible with the help of a tool via a recess 38 in the fastening device 17 that is contoured helically in the cross section.

Accordingly, in the exemplary embodiments of FIGS. 4 to 7 according to the second aspect of the inventions, the fastening device 17 as such is designed resiliently deformable. Here, the fastening device 17 can be contoured U-like, V-like, C-like or helically. By tightening the nuts 23, the respective fastening devices 17 are preloaded.

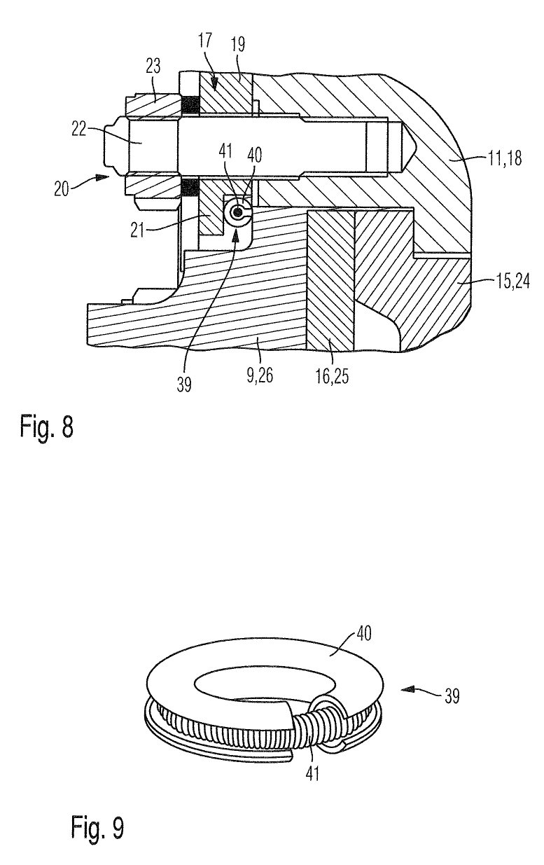

A turbocharger according to a third aspect of the invention is illustrated by FIGS. 8 and 9. According to the third aspect, a resiliently deformable element 39 is positioned between the second section 21 of the fastening device 17 and the flange 26 of the bearing housing 9, which on the one hand supports itself on the second section 21 of the fastening device 17 designed as clamping claw and on the other hand on the flange 26 of the bearing housing 9.

This elastically deformable element 39 preferentially comprises a ring element 40 that is C-like in the cross section, in which a coil spring 41 is received or positioned. By tightening the nut 23 of the fastener 20 shown in FIG. 8, the element 39 is elastically deformed and thus a preloading force provided by the same. With this configuration of the invention, different deformations of bearing housing 9 and inflow housing 11 and preload losses of the connection can also be compensated for during the operation in order to reduce a leakage risk and ensure a secure connection between inflow housing 11 and bearing housing 9 even during high temperature cycles.

In all versions of the invention present here it is possible that the clamping claw or the fastening device 17 is segmented in the circumferential direction, i.e. is composed of multiple segments seen in the circumferential direction.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A turbocharger, comprising:
a shaft;
a turbine configured to expand a first medium, comprising:
a turbine housing; and
a turbine rotor;
a compressor configured to compress a second medium utilizing energy extracted in the turbine during expansion of the first medium, and comprising:
a compressor housing; and
a compressor rotor that is coupled to the turbine rotor via the shaft;
a bearing housing having a flange, arranged between the turbine housing and the compressor housing, and in which the shaft is mounted;
a fastening device;
an inflow housing of the turbine housing having a flange by which the turbine housing connected to the bearing housing via the fastening device is mounted via fasteners to a flange of the inflow housing with a first section and overlaps the flange of the bearing housing with a second section at least in sections; and
resiliently deformable elements are positioned between the first section of the fastening device and nuts of the fasteners configured to provide a preloading force and compensate for preload losses.

2. The turbocharger according to claim 1, wherein between the first section of the fastening device and the nuts of the fasteners multiple resiliently deformable elements formed as disc springs are each positioned stack-like on top of one another or stack-like next to one another.

3. The turbocharger according to claim 2, wherein the preloading force and a spring travel of the resiliently deformable elements is determined in each case by a number and an orientation of disc springs.

4. A turbocharger, comprising:
a shaft;
a turbine configured to expand a first medium, comprising:
a turbine housing; and
a turbine rotor;
a compressor configured to compress a second medium utilizing energy extracted in the turbine during expansion of the first medium, and comprising:
a compressor housing; and
a compressor rotor that is coupled to the turbine rotor via the shaft;
a bearing housing having a flange, arranged between the turbine housing and the compressor housing, and in which the shaft is mounted;
a fastening device;
an inflow housing of the turbine housing is connected to the bearing housing via the fastening device such that the fastening device is mounted via fasteners to a flange of the inflow housing with a first section and overlaps a flange of the bearing housing with a second section at least in sections,
wherein the fastening device is resiliently deformable and provides a preloading force.

5. The turbocharger according to claim 4, wherein the fastening device has a cross section that is one of: U-shaped, V-shaped, C-shaped, or helically shaped.

6. The turbocharger according to claim 4, wherein
the fastening device is contoured U-shaped in cross section,
a first leg of the fastening device provides the first section, with which the fastening device is mounted to the flange of the inflow housing, and the second section, with which the fastening device overlaps the flange of the bearing housing at least in sections,
a second leg extends parallel to the first leg, and
a nut of respective fasteners supports itself on the second leg.

7. The Turbocharger according to claim 4, wherein
the fastening device contoured C-shaped or V-shaped in cross section a free end of a first leg provides the first section with which the fastening device is mounted to the flange of the inflow housing,
a free end of a second leg provides the second section with which the fastening device overlaps the flange of the bearing housing at least in sections, and
a nut of respective fasteners supports itself on a section of the fastening device connecting the two legs.

8. The turbocharger according to claim 4, wherein
the fastening device contoured helically in cross section,
a first end of the fastening device provides the first section, with which the fastening device is mounted to the flange of the inflow housing,
a second end of the fastening device provides the second section, with which the fastening device overlaps the flange of the bearing housing at least in sections, and
a nut of respective fasteners supports itself on the first end.

9. A turbocharger, comprising:
a shaft;
a turbine configured to expand a first medium, comprising:
a turbine housing; and
a turbine rotor;
a compressor configured to compress a second medium utilizing energy extracted in the turbine during expansion of the first medium, and comprising:
a compressor housing; and
a compressor rotor that is coupled to the turbine rotor via the shaft;
a bearing housing having a flange, arranged between the turbine housing and the compressor housing, and in which the shaft is mounted;
a fastening device;
an inflow housing of the turbine housing having a flange by which the turbine housing connected to the bearing housing via the fastening device is mounted via fasteners to a flange of the inflow housing with a first section and overlaps the flange of the bearing housing with a second section at least in sections; and
a resiliently deformable element is positioned between the second section of the fastening device and the flange of the bearing housing, which provides a preloading force.

10. The turbocharger according to claim 9, wherein the resiliently deformable element is a ring element that is C-shaped in cross section, in which a coil spring is received.

11. The turbocharger according to claim 1, wherein the fastening device is a clamping claw that is segmented as seen in circumferential direction.
